(19) United States
(12) Patent Application Publication
(10) Pub. No.: US 2023/0215466 A1
(43) Pub. Date: Jul. 6, 2023

(54) Digital Video Generation depicting Edit Operations to Digital Content

(71) Applicant: Adobe Inc., San Jose, CA (US)

(72) Inventors: Yi Chen Hock, Warrington (GB); Joy Oakyung Kim, Sunnyvale, CA (US)

(73) Assignee: Adobe Inc., San Jose, CA (US)

(21) Appl. No.: 17/568,396

(22) Filed: Jan. 4, 2022

(51) Int. Cl. G11B 27/031; G11B 27/34

(52) U.S. Cl. CPC G11B 27/031; G11B 27/34

(57) ABSTRACT

Digital video generation techniques are described that depict implementation of edit operations to digital content. In one example, a content processing system is configured to generate log data as part of monitoring edit operations that are executed to edit digital content. The log data includes operation data describing the edit operation, time data, and location data indicating a location within the digital content at which the edit operation is executed. Subsequently, a user input is received that selects a location within the digital content. A search module of the content processing system generates a search query based on the location and searches the log data to locate logs of edit operations that correspond to that location. The content processing system, for instance, generates a digital video that depicts a time lapse of execution of the edit operations as following a sequence indicated by the time data.

### BACKGROUND

Digital content creation techniques continue to expand the features included as part of digital content itself as well as the ways in which creative professionals are able to create this digital content through interaction with content processing systems. Accordingly, a corresponding increase in complexity has also been experienced in real world scenarios as part of interacting with these content creation systems. This hinders user access, availability of digital content created using these features, and operation of computing devices that implement the content processing systems.

One technique that has been developed to address this complexity involves capturing digital videos (e.g., as livestreams) of user interaction with the content processing systems which are then shared with other viewers, e.g., as tutorials. Conventional techniques to do so, however, are typically manual and targeted to show operation of specific features of the content processing system, e.g., how to operate a particular tool. This technique introduces additional challenges in that it may be difficult to locate a particular subject of interest. Further, these conventional techniques fail to capture how the digital content is created, but rather are limited to depicting how to interact with different functionality. Consequently, these conventional techniques fail to address the complexities in use of these features to create digital content of interest.

### SUMMARY

Digital video generation techniques are described that depict implementation of edit operations to digital content, e.g., as part of content creation. In one example, a content processing system is configured to generate log data as part of monitoring edit operations that are executed to edit digital content. The log data includes operation data describing the edit operation used, time data describing a time data describing a time at which the edit operation is executed (e.g., as a timestamp), and location data indicating a location within the digital content at which the edit operation is executed.

Subsequently, a user input is received that selects a location within the digital content. A search module of the content processing system generates a search query based on the location and searches the log data to locate logs of edit operations that correspond to that location. The content processing system, for instance, generates a digital video that depicts a time lapse of execution of the edit operations at the location as following a sequence indicated by the time data.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an example digital medium environment configured to support digital video generation depicting edit operations to digital content.

FIG. 2 depicts a system in an example implementation showing operation of a content processing system of FIG. 1 as generating log data.

FIGS. 3 and 4 depict examples of execution of edit operations to edit digital content configured as a digital image.

FIG. 5 is a flow diagram depicting a procedure in an example implementation in which log data is generated by an edit recording system of FIG. 2.

FIG. 6 depicts a system in an example implementation showing operation of the content processing system of FIG. 1 as generating a digital video based on log data generated with respect to FIG. 2.

FIG. 7 depicts an example of a user input specifying a location within digital content that is a subject of a search for corresponding edit operations.

FIG. 8 is a flow diagram depicting a procedure in an example implementation of digital video generation.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Overview

Conventional techniques have been developed in which a digital video (e.g., as part of a livestream) is created to allow other users to view interaction with the content processing system. However, conventional techniques used to implement these digital videos have numerous shortcomings, often because of how digital content is created in real world scenarios.

In a first such example, creative professionals typically alternate interaction with a variety of digital objects included in digital content. The creative professional, for instance, may “skip” between editing different objects in digital content, e.g., to harmonize a visual appearance of the objects within the content. Therefore, in conventional techniques it is difficult for a viewer of the video to focus on a particular object of interest, and consequently is often tasked with viewing an entirety of the digital video even though the viewer is interested in a relatively minor portion of the video.

Further, because significant amounts of time may lapse between interactions with a particular digital object, it may be difficult for the viewer to gain insight into each interaction that was involved in achieving a result of interest. For example, a viewer may be interested in how a character's face is drawn in an illustration. However, the digital video may depict creation of other parts of the character, also. A creative professional, for instance, may “rough in” the face, proceed with creating other parts of the character's body, and then return to complete the face. Therefore, in conventional techniques it is difficult for the viewer to locate and interact with portions of interest. This decreases both user efficiency as well as computational efficiency of content processing systems that support these conventional techniques.

In another example, conventional digital videos typically include visual jumps caused by panning and zoom operations used to show different portions of the digital content and/or different amounts of detail. Because of this, conventional navigation techniques used in an attempt to skip output of particular portions of the digital video that are not of interest fail due to lack of continued visibility of desired portions. Further, in some instance conventional digital videos are limited to showing edits in the digital content itself and do not show an entirety of the user interface provide and therefore limited insight as to operations used to make those edits.

Accordingly, digital video generation techniques are described that depict implementation of edit operations to digital content, e.g., as part of content creation. These techniques support improved navigation between edit operations that are used to generate the digital content and provide improved insight into how these edit operations are utilized to achieve a corresponding result. As such, these techniques also increase operational efficiency of corresponding content processing systems and computing devices.

In one example, a content processing system is configured to generate log data as part of monitoring edit operations that are executed to edit digital content. User inputs, for instance, are received via a user interface output by a content processing system and log data is generated by an edit recording system that describes edit operations executed resulting from the user inputs. A user input, for instance, is received that selects an edit operation to draw a line having a particular thickness. User inputs are then received through interaction with the user interface to draw this line, e.g., detected via touchscreen functionality, input using a cursor control device, and so on. The edit recording system generates the log data by monitoring this interaction. The log data includes operation data describing the edit operation used, time data describing a time data describing a time at which the edit operation is executed (e.g., as a timestamp, as corresponding to a particular frame in a digital video), and location data indicating a location within the digital content at which the edit operation is executed. The log data is associated with the digital content and is searchable to expand ways in which navigation is supported between edit operations used to edit the digital content.

The digital content, for instance, is again output in a user interface. A user input is received that selects a location within the digital content, e.g., by input of a rectangle using a touch-and-drag gesture, “clicking” on a particular digital object, and so on. Continuing with the example above, a viewer of the user interface is interested in a hand of a character depicted in the digital content and wonders how the hand is created. Therefore, a user input is specified through interaction with the user interface through a touch-and-drag gesture to specify the location as a rectangular area within the digital content.

A search module of the content processing system generates a search query based on the location (e.g., coordinates of the rectangular area) and searches the log data to locate logs of edit operations that correspond to that location, e.g., have location data indicating locations disposed within the rectangular area. In other words, the content processing system filters the log data, a result of which is output as logs describing edit operations that occurred at that location. The search result is then used to navigate through those edit operations that occurred at that location as part of editing the digital content.

The content processing system, for instance, generates a digital video that depicts a time lapse of execution of the edit operations as following a sequence indicated by the time data, e.g., the timestamps of corresponding frames of a digital video that captured an entirety of the content creation process. In this way, the digital video supports increased efficiency in navigating to desired edit operations. In an implementation, the content processing system is configured to post the digital video to a content sharing service (e.g., social network service) for access by other client devices via a network. In this way, the content processing system is configured to navigate through the edit operations associated with creating the digital content and is configured to output those operations in a variety of ways. Other examples are also contemplated, further discussion of which is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

Example Environment

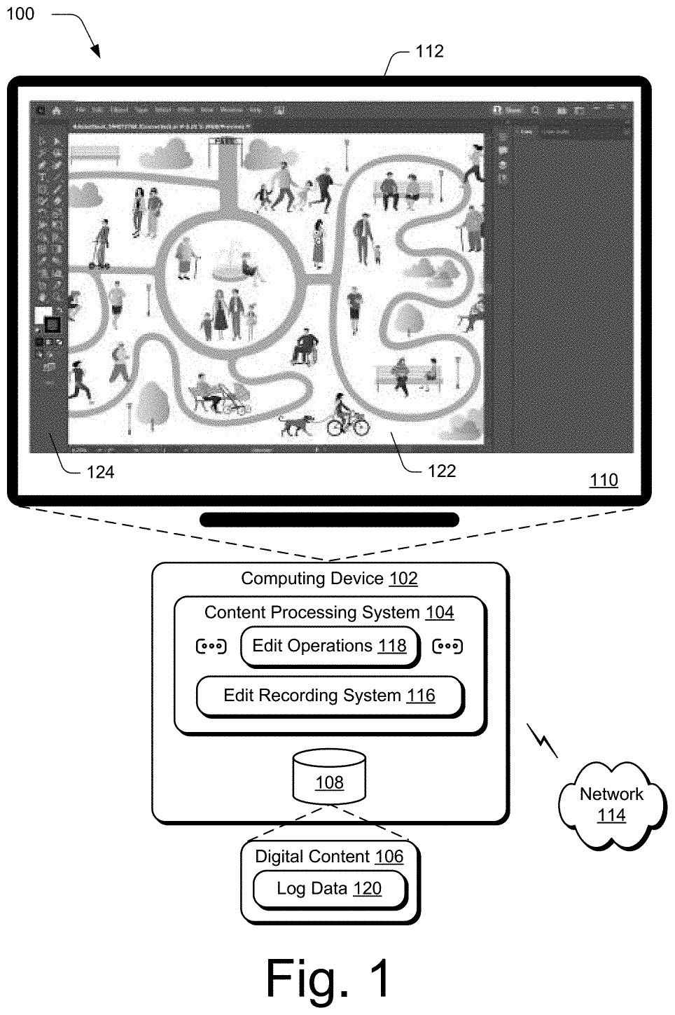

FIG. 1 is an illustration of a digital medium environment 100 in an example implementation that is operable to employ digital video generation and navigation techniques described herein. The illustrated environment 100 includes an example computing device 102, which is configurable in a variety of ways.

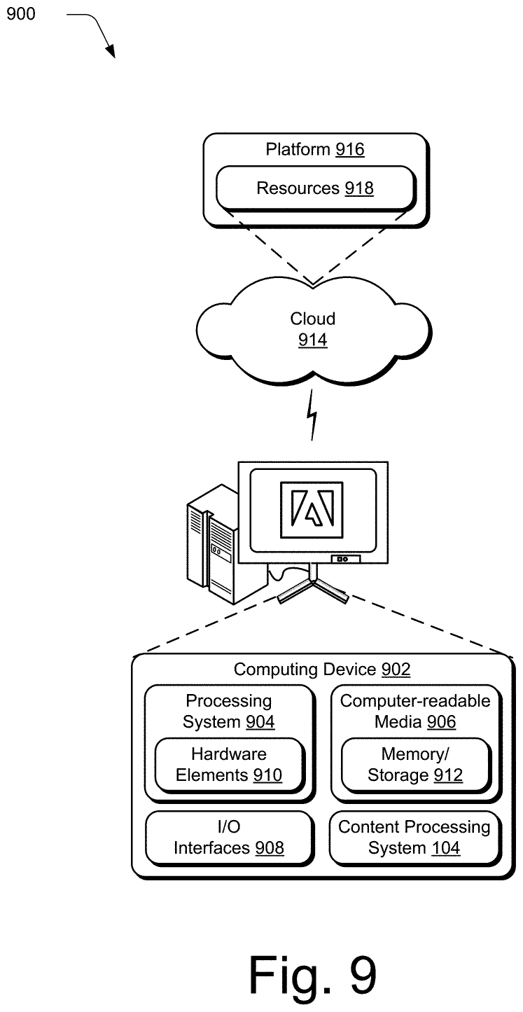

The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, modification of the digital content 106, and rendering of the digital content 106, e.g., in a user interface 110 for output by a display device 112. Examples of digital content include digital images, digital video, digital audio, and any other type of digital content that is capable of being rendered by the computing device 102 for output. Although illustrated as implemented locally at the computing device 102, functionality of the content processing system 104 is also configurable as whole or part via functionality available via the network 114, such as part of a web service or “in the cloud.”

An example of functionality incorporated by the content processing system 104 to process the digital content 106 is illustrated as an edit recording system 116. The edit recording system 116 is configured to monitor edit operations 118 used to edit the digital content 106, and based on this, generate log data 120 that describes execution of the edit operations 118. The log data 120, for instance, is usable to locate “what” is depicted in respective frames of a digital video used to capture an entirety of the content creation process.

In the example user interface 110, for instance, the content processing system 104 is implemented as an application configured to edit a digital image 122. The user interface 110 includes representations 124 of the edit operations 118 that are user selectable to initiate execution of corresponding functionality in order to create the digital image 122. As previously described, creative professionals typically alternate between interaction with a variety of digital objects included in digital content, e.g., between different depictions of characters in the example digital image 122. Conventional content creations scenarios also typically include visual jumps caused panning and zoom operations used to interact with these different digital objects and view different levels of detail corresponding to those objects. Further, significant amounts of time may lapse between interactions with a particular digital object and visual jumps may occur caused by the creative professional.

Accordingly, the edit recording system 116 is configured to generate log data 120 that has increased richness over conventional techniques. The log data 120 is searchable to navigate to corresponding portions of a creative process in order to view implementation of edit operations 118 to particular portions of the digital content 106 including portions of the user interface representing respective edit operations, e.g., menu items. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Log Data Generation

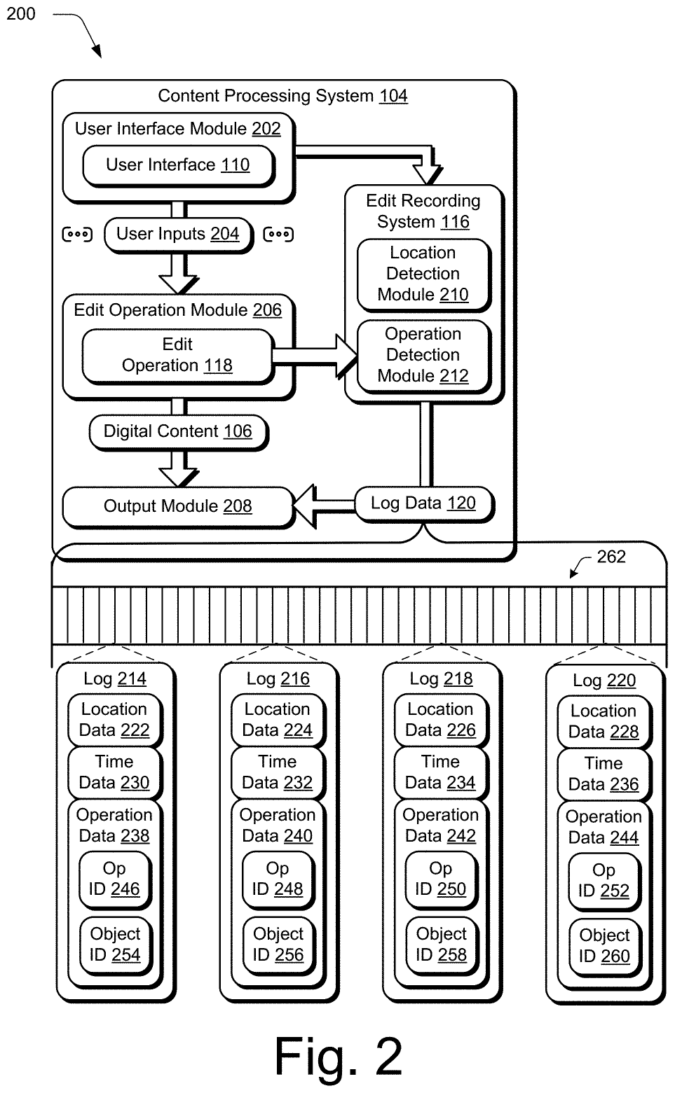

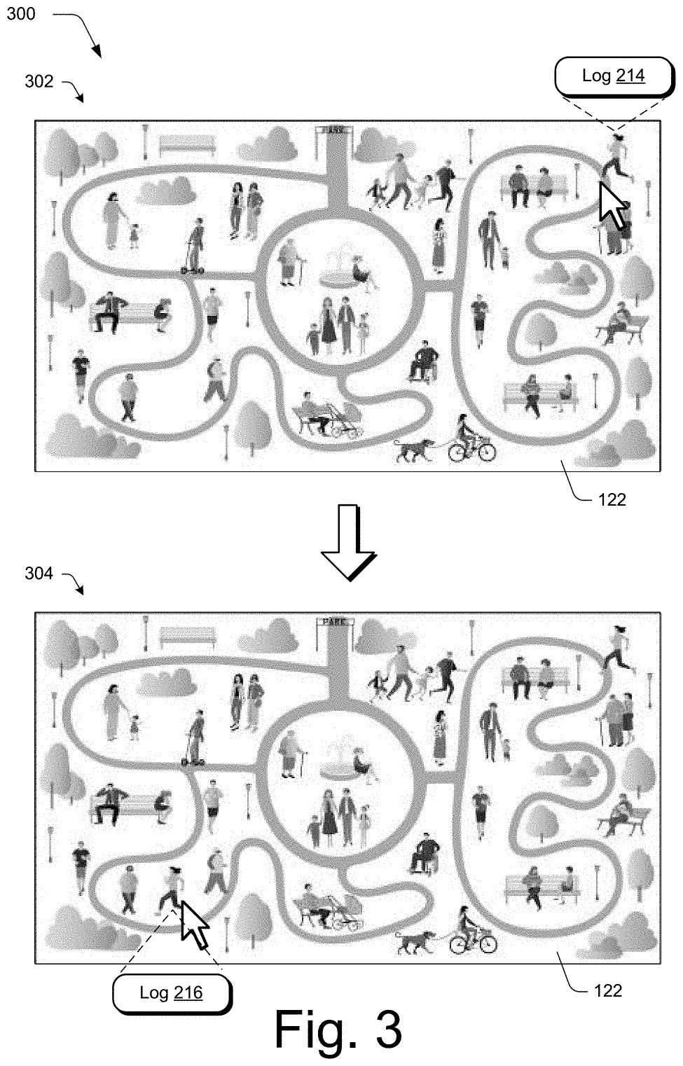

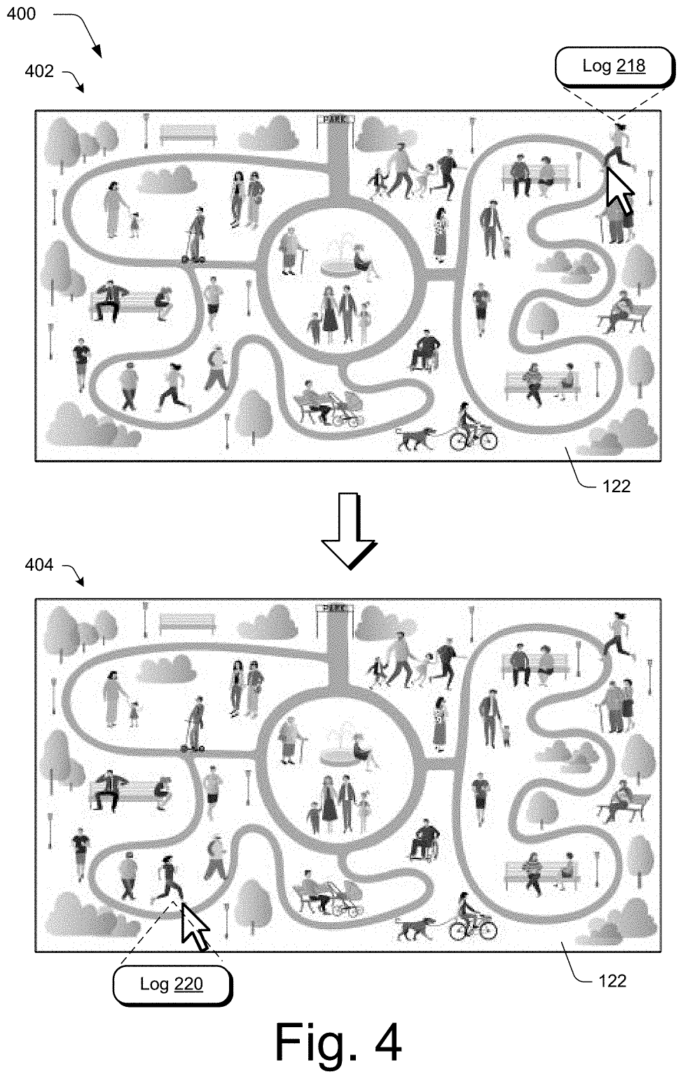

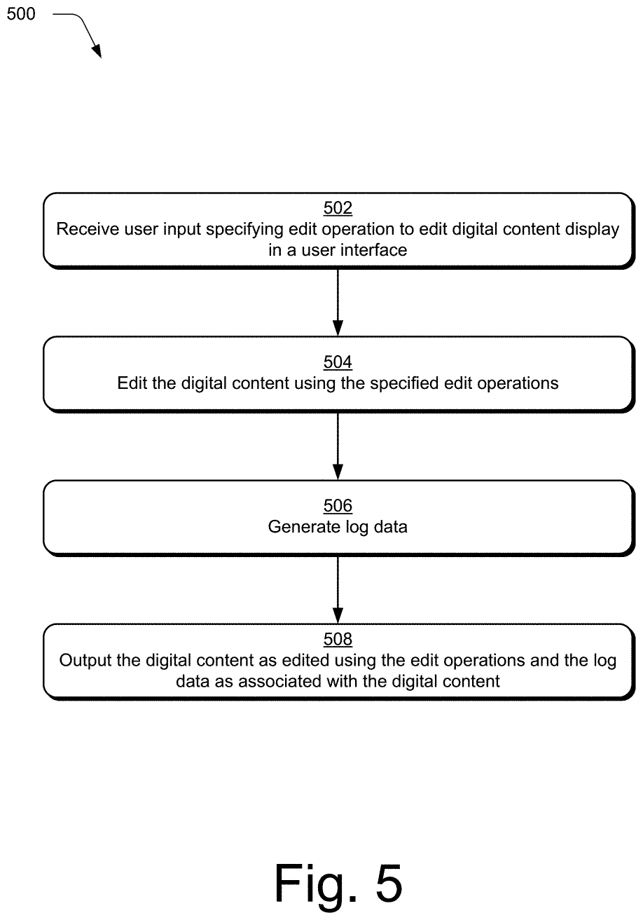

FIG. 2 depicts a system 200 in an example implementation showing operation of the content processing system 104 of FIG. 1 to generate log data 120. FIGS. 3 and 4 depict examples 300, 400 of execution of edit operations 118 to edit digital content 106 configured as a digital image. FIG. 5 depicts a procedure 500 in an example implementation of log data generation by an edit recording system of the content processing system. The following discussion describes log data generation techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5.

Beginning at FIG. 2, the content processing system 104 includes a user interface module 202 that is configured to output a user interface 110. The user interface 110, for instance, includes representations 126 of edit operations 118 that are selectable to initiate the operations as shown in FIG. 1. The user interface 110 also includes a display of digital content 106, which is a digital image 122 in this example that is being edited.

User inputs 204, detected by the user interface module 202, are received by an edit operation module 206. The user inputs 204 specify an edit operation used to edit digital content 106 displayed in the user interface 110 (block 502), e.g., the digital image 122. The user inputs 204 and corresponding edit operations 118 are configurable in a variety of ways to support interaction with a variety of types of digital content 106. In a digital image 122 example, the user inputs 204 include input of strokes, shapes, selection of colors, contrast, filters, gradients, resizing, movement, hole filling, and so forth. Other examples include selection of representations of corresponding edit operations 118 to edit other types of digital content 106, such as a spectrograph of digital audio, timeline of digital video, etc. In an implementation, the edit operations 118 are received as part of recording frames of a digital video capturing creation of the digital content 106.

The digital content 106 is edited by an edit operation module 206 using the specified edit operations 118 (block 504) from the user inputs 204. The edit operation 118, for instance, may involve a brush stroke in the user interface 110 having a specified weight at a particular location within the digital image 122. The digital content 106, as edited, is then output to an output module 208.

During editing of the digital content 106, an edit recording system 116 is configured to monitor edit operations 118 executed by the edit operation module 206, and from this, generate log data 120 (block 506) that describes the execution of the edit operations 118. Functionality to do so is represented by a location detection module 210 and an operation detection module 212. The digital content 106 is then output as edited using the edit operations 118 along with the log data 120 as associated with the digital content (block 508). As a result, the log data 120 describes edit operations 118 that are used to create the digital content 106. This is usable to depict evolution in the editing of the digital content 106, corresponding frames of a digital video used to capture editing of the digital content 106, and so on.

Log data 120 is configurable to describe a variety of characteristics involving execution of the edit operations 118. In the illustrated example, a log 214, 216, 218, 222 is generated each time an edit operation 118 is executed by the edit operation module 206 to edit the digital content 106. Location data 222, 224, 226, 228 describes a location, at which, the edit operation 118 is performed within the digital content 106. The location data 222-228, for instance, describes coordinates (e.g., a bounding area) at which an input is received, e.g., via a cursor-control devices, gesture, and so on, such as to draw a line, drag-and-drop a digital object, freeform line, and so on. In another example, the location data 222-228 describes coordinates of a digital object within the digital content 106 that is a subject of the edit operation 118. Coordinates of the user input 204 is detected, for instance, and based on this the location detection module 210 determines a digital object in the digital content that corresponds to this input, which is stored as the location data, e.g., as corresponding to a boundary of the digital object. In this way, subsequential partial selection of the digital object is supported for inclusion as part of a search as further described in the following section. Other examples include layers, e.g., such that a search result includes operations associated with a particular layer of a digital image without viewing other layers.

Time data 230, 232, 234, 236 is also captured by an operation detection module 212 that describes a time, at which, the edit operation 118 is executed for a respective log 214-220. The time data 230-236, for instance, is configurable as sequential values to indicate respective orders the edit operations 118 are executed. In another instance, the time data 230-236 is configured to indicate corresponding points of time (e.g., frames) in recording digital images of a digital video chronicling user interaction with the content processing system 104 in editing the digital content 106.

Operation data 238, 240, 242, 244 is also stored in respective logs 214-222 in this example that identify the edit operations 118 used along with object IDs 254, 256, 258, 260 that identify digital objects that are a subject of these interactions. The object IDs 254-260 are usable, for instance, as part of a markup language that identifies particular digital objects, e.g., as used by the digital content 106 itself. In another example, the object IDs 254-260 reference IDs used to obtain the digital objects from a content sharing service, e.g., stock image service via a network. The log data 120 is then associated, in one example, by the output module 208 as part of the digital content 106 to provide insight into how the digital content 106 is created. In another example, the log data 120 is associated with a digital video 262 including digital images (e.g., frames) captured of user interaction with the content processing system 104 to create the digital content 106.

FIGS. 3 and 4 depict examples 300, 400 of execution of edit operations 118 that are used to generate respective logs 214, 216, 218, 220 of the log data 120. The examples, 300, 400 are illustrated using first, second, third, and fourth stages 302, 304, 402, 404. At the first stage 302, a log 214 is generated that describes selection of a digital object (e.g., vector object, raster object) and input of an edit operation 118 to “copy” the digital object. The log 214, therefore, includes location data 222 indicating a point within the digital image the user input 204 is received and/or coordinates of the digital object, time data 230 describing a time at which the user input is received 204, operation data 238 describes an operation ID 246 (e.g., to “copy”) and an object ID 254 identifying the digital object, itself, that is being copied.

At the second stage 304, a log 216 is generated that describes selection of another location within the digital image 122 and input of an edit operation 118 to “paste” the digital object. The log 216 generated by the edit recording system 116 includes location data 224 indicating a point within the digital image 122 the user input 204 is received to paste the digital object, time data 232 describing a time at which the user input is received (and therefore corresponding frame of the digital video 262), operation data 240 describes an operation ID 248 (e.g., to “paste”) and an object ID 256 identifying the digital object.

At the third stage 402, user interaction again occurs with respect to the digital object that was a subject of the copy operation, e.g., to change color of portions of the object. Accordingly, the log 218 is generated to again include location data 226 that describes the location that is a subject of the edit operation, time data 234 (e.g., a timestamp of a corresponding frame of a digital video 262), and operation data 242 including an operation ID 250 (e.g., selection of a particular color) and object ID 258 of the digital object.

At the fourth stage 404, user interaction switches back to the digital object that was copied to the location at the second stage 304. Therefore, the log 220 is generated by the edit recording system 116 that includes location data 228 that describes the location that is a subject of the edit operation, time data 236, and operation data 224 including an operation ID 252 (e.g., to change orientation of the digital object and colors within the digital object) and object ID 260 of the digital object. Thus, the examples 300, 400 of FIGS. 3 and 4 describe a scenario that is problematic using conventional navigation techniques because interactions “jumps back and forth” between different digital objects at different locations and at different scales within the digital image 122. In the techniques described herein, however, the log data 120 is searchable to support improved navigation to edit operations 118 of interest used to generate the digital content, examples of which are described in the following section.

Digital Video Generation

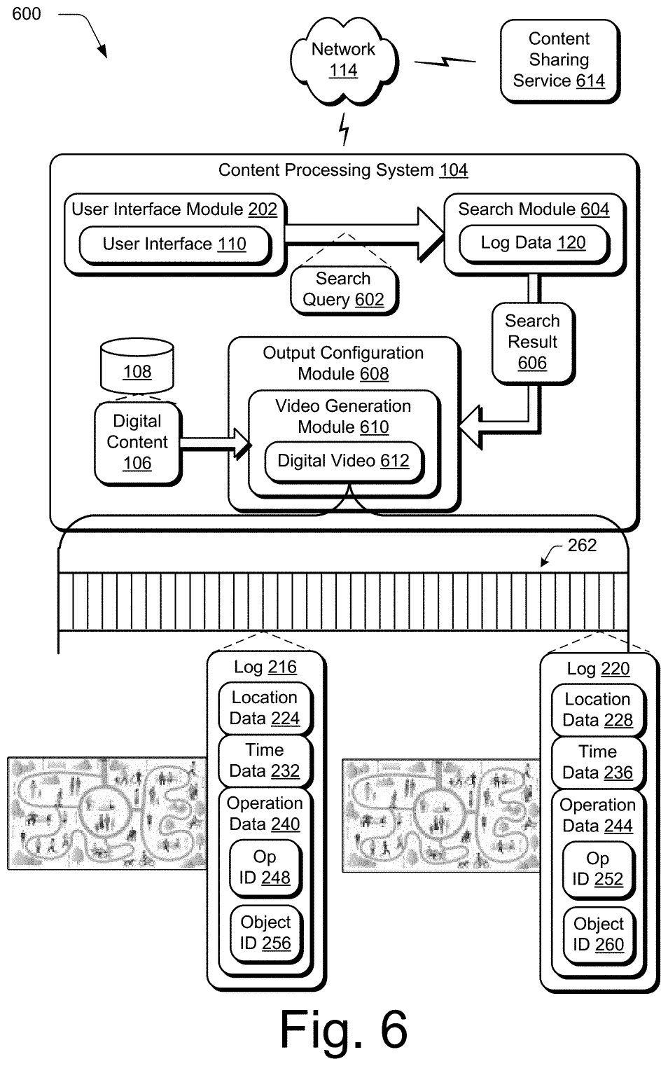

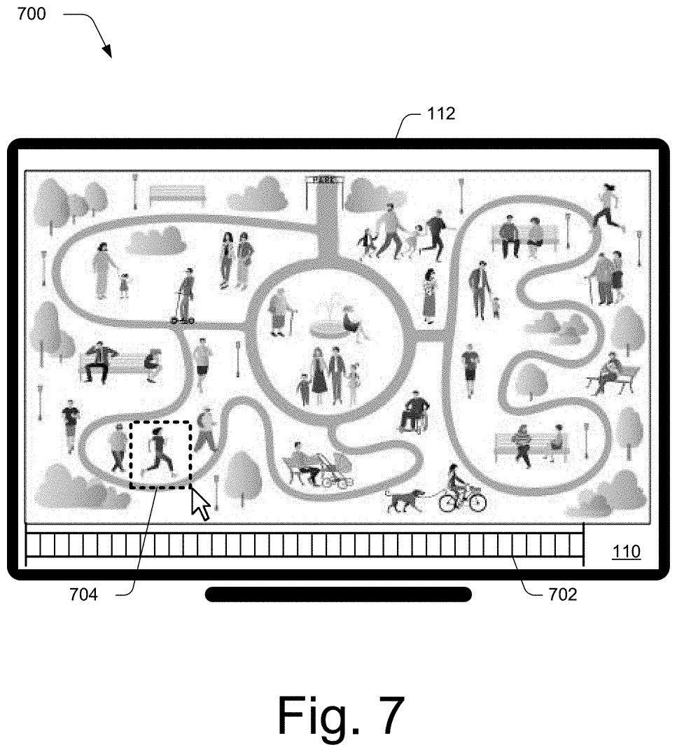

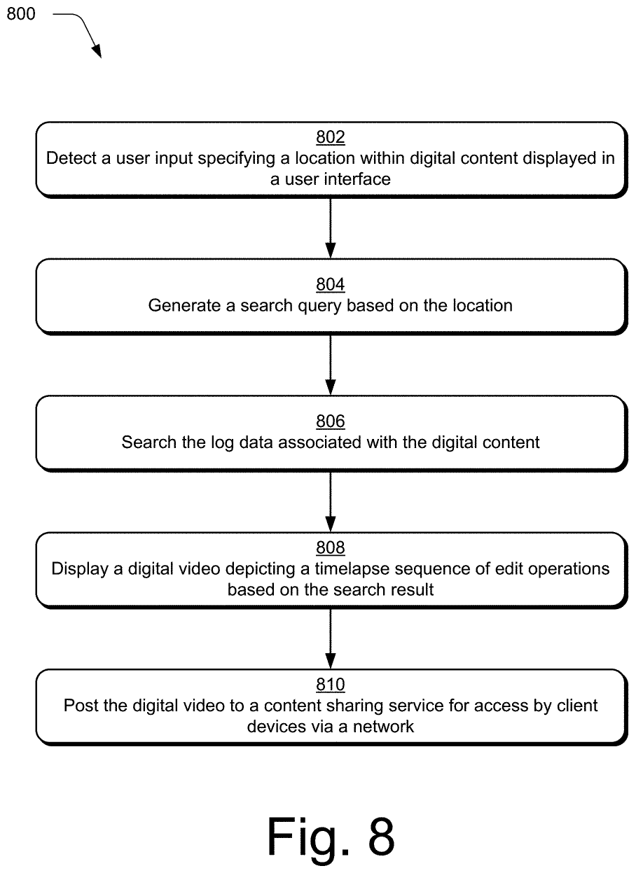

FIG. 6 depicts a system 600 in an example implementation showing operation of the content processing system 104 of FIG. 1 as generating a digital video based on log data generated with respect to FIG. 2. FIG. 7 depicts an example 700 of a user input specifying a location within digital content that is a subject of a search for corresponding edit operations. FIG. 8 depicts a procedure 800 in an example implementation of digital video generation by the content processing system 104 of FIG. 1.

The following discussion describes digital video generation techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 6-8.

In this example, the user interface module 202 is configured to implement a user interface 110, via which, a user input is detected that specifies a location within digital content displayed in a user interface (block 802). As shown in an example 700 of FIG. 7, the user interface 110 includes a display of the digital image 122 edited as described in relation to FIGS. 3 and 4 using corresponding edit operations. The user interface 110 also includes a navigation bar 702 that is configured to support navigation to respective frames of a digital video that captures implementation of edit operations.

A user input is received in this example that specifies a location 704 within the digital image having a digital object of interest. The location 704, for instance, corresponds to a particular character (e.g., jogger) within a map to in order to learn as to how the character is created. Therefore, in this example a boundary is specified through use of a cursor control device that includes the character of interest.

The user interface module 202, responsive to the user input, generates a search query 602 based on the location (block 804). The search query 602, for instance, identifies the location specified via the user input, e.g., as coordinates. The search query 602 is then passed as an input to a search module 604 to search log data 120 (block 806). The search module 604, for instance, searches the logs 214-218 of the log data 120 to locate location data 224-228 that corresponds to the location specified in the search query 602. In this way, the search module 604 “filters” out logs that do not correspond to this location in order to generate a search result 606.

Continuing with the example of FIGS. 3-4 above, log 216 and log 220 generated as depicted in the second and fourth stages 304, 404 correspond to the location, whereas log 214 and log 218 do not. Therefore, the search result 606 includes logs 216, 220 and filters out logs 214, 218 from the log data 120. Similar functionality is also usable to specify particular edit operations and/or digital objects through use of respective operation IDs or object IDs, e.g., to further refine the search to find particular editing operations, digital objects, and so forth.

The search result 606 is passed form the search module 604 to an output configuration module 608 for configuration of the result for output, e.g., in a user interface 110. In one example, the search result 606 is output as a list indicating representations of edit operations 118 employed at the location, digital objects that are the subject of the operations, an order the operations are executed, times at which the operations are executed, and so on. The representations are user selectable to navigate to corresponding configurations of the digital content 106 as being edited by those operations.

In another example, a video generation module 610 is configured to generate a digital video 612 having frames based on the search result 606. As previously described, the content processing system 104 may be incorporated to record a digital video 262 showing creation of the digital content 106, e.g., using the video generation module 610. A search result 606 is then used to locate corresponding portions of the digital video 262 that pertain to edit operations performed at a particular location, e.g., as corresponding to log 216 and log 220.

The video generation module 610 is then used to extract those frames from the digital video 262 to generate a targeted digital video 612 showing edit operations that are relevant to the particular location. The video generation module 610, for instance, may generate the digital video 612, automatically and without user intervention, by extracting intervals of frames from the digital video 262 disposed adjacent to frames of interest. Smoothing and transition techniques are then used, automatically and without user intervention, to provide a seamless experience, e.g., through normalizing scale of the frames to each other, focus on particular digital objects of interest, and so on. The digital video 612 is then displayed as depicting a timelapse sequence of edit operations based on the search result 606 (block 808). Output of the frames, for instance, may be “slowed down” such that a viewer of the digital video 612 is able to recognize nuances in creation of the digital content at the respective location.

In an implementation, the content processing system 104 also includes functionality to post the digital video 612 to a content sharing service for access by client devices via a network 114 (block 810). The content sharing service 614, for instance, is configured as a social network service via which client devices are able to perform search to locate digital video 612 of interest. In an implementation, posting of the digital video 612 includes tags identify particular edit operations, locations, digital objects, and so on. In this way, the digital video 612 is also searchable and improves an ability to navigate to particular digital videos 612 of interest over conventional techniques that relied on manual tagging of digital videos, which lack accuracy, and thus also improves operations of computing devices that implement these search techniques.

In one such example, a “chapterization” strategy is implemented in which the digital video 612 is generated as a capture of the overall digital video. Popularity metrics are usable to further refine how digital video are automatically generated in the future, e.g., through the result of machine learning and a machine-learning model. The machine learning model, for instance, is trainable based on upvotes/downvotes to particular chapters and used to guide generation of chapters in the future. A user interface is output in this scenario, also, that is configured to support corrections made by an originator of the overall digital video, which is also usable as part of the training.

Implementation of these techniques in other digital content creation scenarios is also contemplated. For digital videos that capture content creation over a significant amount of time (e.g., university lectures, educational videos, long meetings) data such as speech-to-text transcriptions, PDF/slides document that are shown in the video having an intrinsic structure itself, and user-generated timestamps of importance that are labeled with some kind of tag/topic are usable to search for particular portions of interest. Further, these search queries may include speech-to-text interaction, object recognition, and so forth. A user interface element (e.g., time bar) is then usable to display “where” in the output these search results are located. For example, a viewer may wish to navigate to parts of a lecture where there include definitions of terms. This may be beneficial to viewers who are unfamiliar with the domain, but not as useful to viewers who already know the terms. So, the flexibility of being able to query for the type of shortened digital video as desired supports dynamic digital video generation techniques.

Example System and Device

FIG. 9 illustrates an example system generally at 900 that includes an example computing device 902 that is representative of one or more computing systems and/or devices that implement the various techniques described herein. This is illustrated through inclusion of the content processing system 104. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment, a method implemented by a computing device, the method comprising:
detecting, by the computing device, a user input identifying a location within digital content displayed in a user interface;
generating, by the computing device, a search query based on the location;
receiving, by the computing device, a search result identifying edit operations corresponding to the location that are used to edit the digital content; and
displaying, by the computing device, execution of the editing operations on the digital content in the user interface.

2. The method as described in claim 1, further comprising searching log data associated with the digital content using the search query and wherein the edit operations identified in the search result are identified from the log data.

3. The method as described in claim 2, wherein the log data includes:
operation data describing a plurality of edit operations used to edit the digital content through interaction with a user interface of a content processing system;
time data indicating at time, at which, the plurality of edit operations are executed, respectively; and
location data indicating a plurality of locations at which the plurality of edit operations are executed with respect to the digital content.

4. The method as described in claim 1, wherein the user input identifies the location by specifying a boundary within the digital content or a digital object displayed within the digital content in the user interface.

5. The method as described in claim 1, further comprising generating a digital video depicting a timelapse sequence of the edit operations from the search result as being used to edit the digital content and wherein the displaying is performed using the digital video.

6. The method as described in claim 5, wherein the digital video depicts selection of representations used to initiate execution of the edit operations.

7. The method as described in claim 1, wherein the user input further identifies a particular edit operation of the edit operations, the search query specifies the particular edit operation, and the edit operations of the search result correspond to the particular edit operation as performed at the location.

8. The method as described in claim 7, wherein the user input includes selecting a representation from a plurality of representations of edit operations used to edit the digital content, the plurality of representations generated by searching log data associated with the digital content.

9. The method as described in claim 1, wherein:
the user input further identifies a digital object within the digital content;
the search query specifies the digital object; and
the edit operations in the search result correspond to the digital object.

10. The method as described in claim 1, wherein the detecting, the generating, the receiving, and the displaying are performed in real time as the user input is received via the user interface.

11. The method as described in claim 1, wherein the digital content is a digital image.

12. In a digital medium environment, a system comprising:
a user interface module implemented by a computing device to receive user inputs specifying edit operations to edit digital content displayed in a user interface;
an edit operations module implemented by the computing device to edit the digital content using the specified edit operations;
an edit recording system implemented by the computing device to generate log data describing:
the edit operations,
a plurality of locations at which the plurality of edit operations are executed within the digital content, and
a plurality of time data describing respective times at which the plurality of edit operations are executed; and
an output module implemented by the computing device to output the digital content as edited using the edit operations and the log data as associated with the digital content, the log data searchable to locate a respective said edit operation based on respective said location, at which, the respective said edit operation occurred with respect to the digital content.

13. The system as described in claim 12, wherein the log data is searchable to generate a search result as a digital video depicting a timelapse sequence of edit operations from the search result as being used to edit the digital content.

14. The system as described in claim 12, further comprising a search module implemented by the computing device to search the log data associated with the digital content using a search query that specifies a respective location within the digital content and generate a search result identifying edit operations corresponding to the location that are used to edit the digital content.

15. The system as described in claim 14, further comprising an output configuration module implemented by the computing device to generate a digital video depicting a timelapse sequence of the edit operations based on the search result.

16. The system as described in claim 15, wherein the output configuration module is further configured to post the digital video to a content sharing service for access by client devices via a network.

17. In a digital medium environment, a system comprising:
means for detecting a user input identifying a location within digital content displayed in a user interface;
means for searching log data, to generate a search result, associated with the digital content based on the location, the log data describing a plurality of edit operations used to edit the digital content, a plurality of locations at which the plurality of edit operations are executed within the digital content, and a plurality of time data describing respective times at which the plurality of edit operations are executed; and
means for generating a digital video based on the search result, the digital video depicting a timelapse sequence of edit operations as having occurred at the location.

18. The system as described in claim 17, wherein the user input identifies the location by specifying a boundary within the digital content or a digital object displayed within the digital content in the user interface.

19. The system as described in claim 17, further comprising means for display the digital video in the user interface.

20. The system as described in claim 19, wherein the displaying means is configured to display the digital video in the user interface in real time as the user input is received by the detecting means.
